(19) United States
(12) Patent Application Publication
(10) Pub. No.: US 2014/0058970 A1
(43) Pub. Date: Feb. 27, 2014

(54) DYNAMIC CHANGE OF ADDRESS NOTIFICATION

(71) Applicant: United States Postal Service, Washington, DC (US)

(72) Inventors: Michael Amato, Reston, VA (US); John J. Mampe, Forth Worth, TX (US)

(73) Assignee: United States Postal Service, Washington, DC (US)

(21) Appl. No.: 14/071,466

(22) Filed: Nov. 4, 2013

Related U.S. Application Data
(63) Continuation of application No. 10/150,393, filed on May 16, 2002.
(60) Provisional application No. 60/291,009, filed on May 16, 2001.

(51) Int. Cl. G06Q 10/08

(52) U.S. Cl. CPC G06Q 10/083
USPC 705/330

(57) ABSTRACT

A method is described that provides a notification to the sender or mailer of a mailpiece when the addressee of the mailpiece has changed address. One step in the method includes creation of an updated delivery code that may comprise both the forwarding address of the addressee, the sender's address information, and corresponding barcodes. The postal delivery system sends the mailed item to the forwarding address and provides the sender with the updated information for the addressee. The notification can occur by electronic message systems or delivery of a physical notification.

### CROSS-REFERENCE TO RELATED APPLICATIONS

The present application is a continuation and claims the priority benefit of U.S. patent application Ser. No. 10/150,393 filed May 16, 2002, which claims the priority benefit of U.S. provisional application number 60/291,009 filed May 16, 2001, the disclosures of which are incorporated herein by reference.

### GOVERNMENT INTERESTS

The invention was made by an agency of the United States government or under a contract with an agency of the United States government, the United States Postal Service (“USPS” or “Postal Service”), an independent establishment of the executive branch of the U.S. government.

### BACKGROUND OF THE INVENTION

1. Field of the Invention

The present invention relates generally to a system and method of providing a change of address notification. More specifically the invention relates to automatic methods for providing an electronic change of address notification to mailers who subscribe to notification services from the USPS. The invention further relates to sender codes and forwarding codes, which may be in barcode format, and that represent information such as data indicative of the mailer, the recipient's old and new addresses, and the mailpiece. The sender codes and forwarding codes may be placed on labels that are applied to pieces of mail such that the codes are readable by barcode readers.

2. Description of the Related Art

Delivery service providers, including mail delivery providers such as the USPS, are faced with certain challenges presented by customers who change address. Misdirected mail that arises when a customer relocates is a source of inefficiency to the entity sending the mail. Likewise the time and resources expended by the entity handling the mail also represent lost resources. The USPS for example handles millions of mailpiece items in a calendar year, and the inefficiency and waste associated with misdirected mail carries significant costs.

Under current systems, when a person moves he may request a change of address notification through a manual procedure. In this manner the individual fills out a change of address card, or more likely multiple change of address cards. An individual would ideally fill out such a card for each correspondent whom he wishes to notify. The change of address card is then delivered, via the mail, to the party being notified of the address change. Upon receipt of the change of address notification, the recipient of the notice corrects the address in its own records.

This manual system has limitations, however. It relies on the individual sending a timely change of address notification. If the individual is tardy in doing so, there will be a time lag during which mailers may send mail to the person's old address. Also, individuals seldom provide change of address notifications to all their correspondents. More typically an individual may notify principal correspondents while simply failing or forgetting to notify others. Moreover certain businesses or entities who practice bulk mailings or volume mailings may not be regular correspondents with an individual and therefore would not receive a change of address notice. Even within the mailer's own organization, if for example, the mailer is a business, the manual processing of change of address notices once they are received is both time consuming and subject to human error. An automated system would provide numerous benefits to overcome these limitations.

The USPS has initiated certain automated change of address notification systems in an attempt to ameliorate the above situation. The systems take advantage of the development of labeling and barcode technology now practiced by both the Postal Service and many sophisticated mailers. Generally, mail pieces have a ZIP Code that identifies the delivery destination, and which mailers also represent in a machine readable POSTNET code format. When represented by barcode in the POSTNET format this encodes both the full ZIP Code and supplemental delivery information such as the last digits of a street address or an apartment number. This POSTNET code thus identifies a unique mail delivery destination, e.g., someone's particular mailbox. In addition mailers may also place additional data on a mailing label that is also in barcode format. This sender code, called a PLANET code, may contain a variety of information. This optional, mailer-assigned information, may include an embedded mailer id, subscriber information, calendar information, or address information. Thus, the PLANET code gives the mailer the ability to track a mail piece when the Postal Service scans it and provides location information back to the mailer. The Postal Service makes information available by offering such services to subscribers for a fee. The combination of the destination ZIP Code data in POSTNET code format and the PLANET code also creates a unique machine readable record for a mail piece and a delivery location.

One change of address notification system that relies on this barcode technology is known as the Computer Forwarding System (“CFS”). In the typical operation of the CFS a mailpiece such as a magazine would first go out with a letter carrier to an individual's old address. The carrier, upon attempting delivery, realizes that the addressed individual doesn't live there anymore and pulls the mailpiece back from the street. The letter carrier returns the magazine to the local sorting plant whence it is forwarded to a regional CFS site, a Processing and Distribution Center. The Postal Service has Processing and Distribution Centers (“P&DC”) in various regional locations. There, it gets keyed with the new address, goes back out to the sorting automation, gets sorted, goes to the next P&DC, if necessary, and is redelivered. Of course, there is a large time delay to go through that CFS route. So each time a mailer sends out a piece with the old, wrong address, time and resources are wasted, and the addressee faces a long delay before the item is actually delivered to the new address.

A particular limitation associated with the CFS relates to notification methods that apply to bulk mail carriers such as magazines. The previous CFS system tried using the ZIP Code to forward mail. Using the ZIP Code to forward mail caused problems, however, because when a second POSTNET bar code is applied to the front of the mail piece, it's difficult to tell which of the two bar code addresses the mail piece is supposed to be sent to. To solve this problem, the CFS system relies on covering up the old bar code. This is easy to do when the ZIP Code is on letters in the lower right, but if the ZIP Code is on a magazine or large flat item, there is no preferred code reading location. These items require that a human operator position the yellow forwarding label over the original address and machine readable POSTNET code to prevent it from being read a second time.

In another attempted solution, a second differentiated PLANET code encompassing the new forwarding address was placed on forwarded mail pieces. To differentiate from the mail piece's original PLANET code, the new code had a special forwarding identifier, for example, two special characters identifying it as a forwarding piece. It also contained the new designated forwarding ZIP Code, so that automated sorting equipment could sort that mail piece to the new address. To retain the same code length as the original POSTNET code, the last two characters of the 12 digit POSTNET code were truncated. This solution helped deliver the item to the customer, but did nothing to prevent the mailer from mailing again to the old address.

Thus, it would be advantageous to provide an automated change of address notification system. Such a system should provide speedy notice to the mailer. The system should also provide information to the mailer such that the mailer is advised of both the customer's old address and new address. In this manner the mailer will know definitively and unambiguously what address should be used in the future. Finally, it would be advantageous if such a notification system also provided information to the mailer regarding the status of each individual mailpiece sent by the mailer. In this manner the mailer would know exactly which mailpieces have been sent to what particular address, old or new.

### SUMMARY OF THE PRESENTLY CLAIMED INVENTION

The present invention provides a solution to the above-identified problems in change of address notification systems. The invention features an automated change of address notification system that provides a timely notice to a mailer. The notification provides information to the mailer that reflects both the old and new address of a mailer customer who has changed address. Further the notification reflects information related to the particular mail piece.

The invention constructs a data record containing the original mailer-applied PLANET code and POSTNET code, and a second postal-applied PLANET code containing a forwarding ZIP Code. By associating that mailer id with the mailer, the system can notify the mailer of both the old and the new destination ZIP Codes electronically as soon as it is put on a mail item for forwarding. The mailer can then update his mailing list by using the new delivery point code to retrieve the address information, and any subsequent mailings by the mailer can then be sent to the new address. There is no delay waiting for the postal service to notify the mailer using the old notification process (for mailers who have already signed up for forwarding notification on first-class mail pieces) that the customer moved. Nor must the mailer wait for the customer to notify the mailer; the notification is done as part of the forwarding process.

In the present invention, once the piece goes through the CFS unit it gets a new label with PLANET code information. The information on the PLANET code label can thus be scanned and recorded by all the sorting automation. Using the new PLANET code, the system can link up the mailer, the customer id, and the new ZIP Code and send that information back to the mailer almost instantaneously via electronic communication. The mailer then could automatically update their mailing list proactively. Thus, the next issue of a magazine sent out by the mailer, for example, will have the correct address if the mailer proactively maintains its mailing list.

The forwarding PLANET code also contains the original customer number, but this may not be needed because the mail piece also has the original customer ZIP Code, and the new customer ZIP Code. But, if the mailer needs the customer number to refine their mailing list, that could be provided too. In that case, the mailer ID, the customer ID, the original zip code, and the forwarding zipcode from the second PLANET code all go back to the mailer. Mailers get a PLANET code mailer ID by signing up for one.

One advantage of this invention over the current methods is that it speeds things up considerably. The mailers who will benefit directly from this invention are those with mailer ids; currently that includes a major mailer who subscribes to the notification service and utilizes PLANET codes. The principles of the invention, however, apply to all types of mailers.

A further advantage of the present invention is the automated nature of the change of address notification. In contrast with manual methods, the automated address notification eliminates a source of human error. By providing an electronic communication between the delivery service and the mailer, the mailer receives timely notification.

An additional advantage of the present invention is the increased efficiency and speed in notifying those entities and individuals who utilize the mail service of a change in address. The mailer will now receive notification as to a specific piece and a customer's old and new address. Thus the mailer can best determine how to change future delivery practices for that individual. With knowledge regarding an individual mail piece, the mailer also knows where it is in the delivery process. Thus, for example, if a customer contacts a mailer inquiring as to the status of an expected delivery, the mailer can confidently determine the location of the expected piece. If a magazine delivery is in question, the mailer, learning that a mail piece is en route to the new address, need not send out a duplicate copy of the magazine issue in response to the customer inquiry.

Another advantage of the present invention is the savings realized to the Postal Service in time and manpower due to the decrease in mail inadvertently directed to an old address.

Still a further advantage of the present invention is the improvement realized to the mail addressee in receiving mail.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claim. It is to be understood that both the foregoing general description and the following detailed description are exemplary and explanatory only and are not restrictive of the invention, as claimed. Thus, the present invention comprises a combination of features, steps, and advantages which enable it to overcome various deficiencies of the prior art. The various characteristics described above, as well as other features, will be readily apparent to those skilled in the art upon reading the following detailed description of the preferred embodiments of the invention, and by referring to the accompanying drawings. The accompanying drawings, which are incorporated in and constitute a part of this specification, illustrate embodiments of the invention and, together with the description, serve to explain the principles of the invention.

### BRIEF DESCRIPTION OF THE DRAWINGS

For a more detailed description of a preferred embodiment of the present invention, reference will now be made to the accompanying drawings, which form a part of the specification, and wherein:

FIG. 1 is a diagram that shows the delivery system of the present invention.

FIG. 2 is a flowchart that shows the steps in the process for dynamic address change notification.

### DETAILED DESCRIPTION

Reference will now be made in detail to exemplary embodiments of the invention, examples of which are illustrated in the accompanying drawings. Wherever possible, the same reference numbers will be used throughout the drawings to refer to the same or like parts.

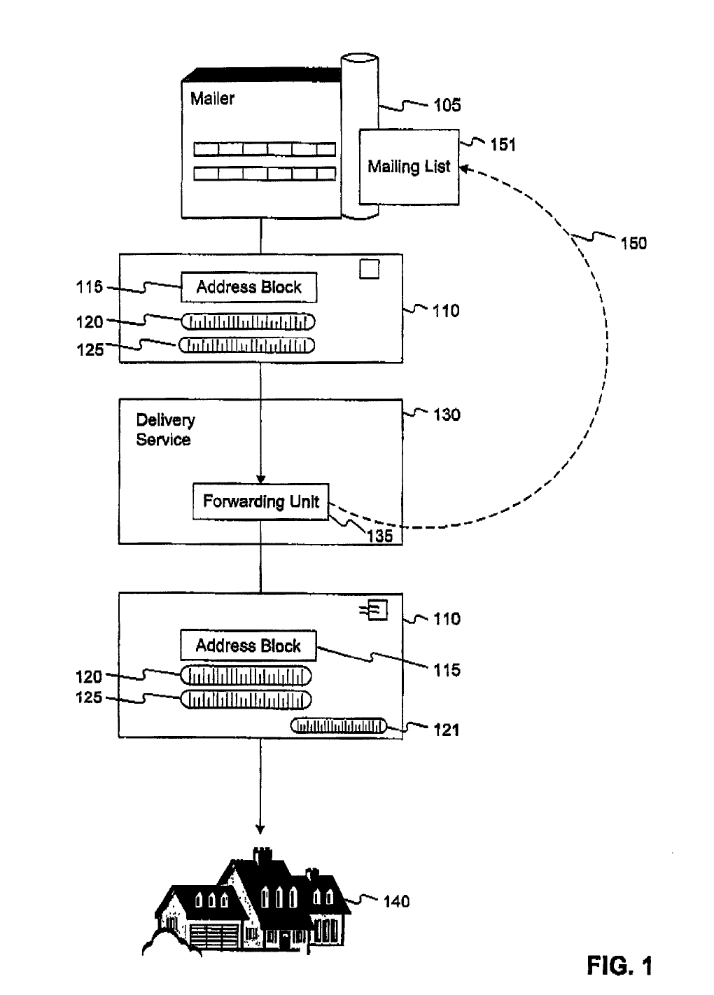

Referring initially to FIG. 1 there is shown a block diagram of a delivery system consistent with the principles of the present invention. FIG. 1 shows a mailer 105, sending a mail item 110 to a delivery service 130. Mail item 110 may be any deliverable, such as a letter, magazine, or package. Delivery service 130 may be any delivery service, such as the USPS.

Mail item 110 has an address block 115, which specifies the name and address of a customer 140. Mail item 110 also has a sender code 120, which specifies information selected by the mailer. Information included in the sender code is the mailer 105, the customer 140, and the mail item 110. The information in sender code 120 that represents information, such as the mailer, customer, and mail item may itself be in a code that is understood by any computerized system used by the sender and the delivery service. Thus for example information identifying the mailer may be in the form of a mailer id. The USPS's PLANET code is an example of a sender code, although sender code 120 does not necessarily have to be a PLANET code.

Mail item 110 also has a destination code 125, which specifies the location, or delivery destination, for customer 140. In a preferred embodiment destination code 125 is the POSTNET Code utilized by the USPS. Destination code 125 identifies a unique delivery location for customer 140. Address block 115, sender code 120, and destination code 125 are generated for each mall item that mailer 105 sends out by using a mailing list 151.

One skilled in the art will recognize that sender code 120 may also specify, among other things where data concerning mail item 110 is to be delivered. Thus the mailer 105 may request that notification be sent to a particular electronic communication route.

If customer 140 has recently moved, delivery service 130 processes mail item 110 using a forwarding unit 135. The USPS P&DC is an examples of such a forwarding unit. Forwarding unit 135 redirects mail item 110 from customer 140's old address to the new address. During this process, forwarding unit 135 applies a second, forwarding sender code 121 to mail item 110. Forwarding sender code 121 is applied to mail item 110 in such a manner that sender code 120, destination code 125 and forwarding sender code 121 are all visible. When in barcode format, all codes should be readable by mechanical or optical device. Forwarding sender code 121 specifies the customer's new forwarding address. Forwarding sender code 121 allows automated sorting machinery within forwarding unit 135 to sort mail item 110 for redelivery to the new address of customer 140. Forwarding sender code 121 also allows a mail carrier to deliver mail item 110 to customer 140 at the new address. The sorting in forwarding unit 135 is preferably automated, employing devices that scan the barcodes and sort according to the information therein contained.

It will be apparent to one of ordinary skill in the art that certain steps in the dynamic change of address notification may be aided and assisted through standard computer processing techniques. Thus data such as the customer's forwarding address may be stored on computer memory of a forwarding unit computer or some other computer of the delivery service. Data related to the mailer or sender, such as sender code 120, may also be stored on such computer memory. This data may include for example the electronic link to use when providing notices to the mailer. Data that is found on sender code 120 and destination code 125 may be converted to electronic form and inputted into the forwarding unit or delivery service computer system for processing. In this manner, the forwarding address that is within forwarding sender code 121 may be identified through data processing techniques, conducted on the forwarding unit computer or delivery service computer, that match the customer's old address with his changed address. Similarly, an electronic notification to mailer 105 may be composed through programs or systems on a forwarding unit computer, or other delivery service computer, that collect sender code 120, destination code 125, and forwarding sender code 121 for simultaneous transmission to mailer 105.

In a preferred embodiment, forwarding sender code 121 is in the format of a second PLANET code. However, unlike sender code 121 which contains information related to mailer 105, forwarding sender code 121 when in PLANET code format contains the new address of customer 140. The PLANET code found in forwarding sender code thus contains the address information of a POSTNET code for the new address that has been reformatted to fit the PLANET Code. The PLANET Code may use the first two digits of the PLANET Code to identify it as forwarding mail with the remainder of the code to be interpreted as if it were POSTNET Code provide ZIP Code information. Thus for a flat mail piece, there would be two PLANET Codes on the piece and one POSTNET code. The record for the mailer would include the original POSTNET ZIP Code, the original PLANET Code data, and the new PLANET Code data which would represent the forwarding ZIP Code data.

It will be understood that when ZIP Code information is placed in PLANET Code format, data fields of the PLANET Code may need to be extended or the POSTNET Code shortened. This may be necessary when systems utilize versions of software that recognize POSTNET Code as having more fields than PLANET Code. For example a precise delivery point may be represented with 14 digits corresponding to ZIP Code+4 extended ZIP Code digits+2 unique delivery point digits+check sum. That may call for an extended PLANET Code format. Alternatively, the POSTNET Code may be shortened by eliminating the 2 unique delivery point digits from the code. Such a shortened POSTNET Code would fit in the PLANET Code format. Systems can be designed wherein both the POSTNET and PLANET Codes have corresponding data fields such that forwarding address information may be completely represented in the fields available in that version of PLANET Code.

Forwarding unit 135 also notifies mailer 105 via an electronic communication path 150 that mail item 110 is being forwarded. The notification preferably occurs immediately upon the selection of forwarding sender code 121. In a preferred embodiment, the forwarding unit's computer system will electronically generate a forwarding sender code. Thus the electronic notification can occur before, simultaneously with, or after the physical creation of the forwarding sender code that is applied to the mail item. The electronic record comprising the sender code 120, the original destination code 125 or unique identifier for the mail item 110, and the forwarding sender code 121 may be transmitted to mailer 105.

In one embodiment, forwarding unit 135 supplies all the information specified in forwarding sender code 121 to mailer 105, and mailer 105 uses the information to automatically update mailing list 151, so that the next time mailer 105 sends a mail item 110 to customer 140, the address block 115, sender code 120, and destination code 125 all reflect customer 140's new address. In another embodiment, forwarding unit 135 supplies forwarding sender code 121, sender code 120, and destination code 125 to mailer 105.

The notification via electronic communication path 150 may take place through any known electronic communication system. As between the mailer 105 and delivery service 130, the notification is a transfer of data in electronic form. The electronic notification may itself comprise certain steps related to data processing within delivery service 130 such as reading the data, identifying data corresponding to a notification subscriber, sorting the data into files, and transmitting the data. Mailer 105 may also perform certain steps related to the data transmitted with the notification. Such steps may include receiving the data, sorting it into files, as for example, by geographical area, customer, or mailed item, and recording the change of address within data storage areas. The hardware and software necessary to effect the electronic communication may be any of the known systems of electronic communication. E-mail communication via the internet is one example of an acceptable electronic communication medium. Bulletin board posting may also be employed.

In a preferred embodiment sender code 120 and destination code 125 are applied to mail item 110 on a label in the form of a machine-readable bar code. Forwarding sender code 121 is also applied by label with a machine-readable bar code. Any such bar code is contemplated by this invention provided that the code may itself be recognizable, readable, or scannable by an automated machine reader.

While codes 120, 121, and 125 are herein described as “machine” or “mechanical” readable or capable of being recognizable or scanned, it should be understood that optical recognition devices and systems including laser-based readers and scanners, and digital scanners, are also within the scope of the invention. Codes other than bar codes may be employed. Thus it would also be within the scope of the present invention to provide a sender code 120, forwarding sender code 121, and destination code 125 in a format that could be transferred into electronic data via optical character recognition. The technology regarding bar code representations and the mechanized reading of such bar codes is understood by those skilled in the art.

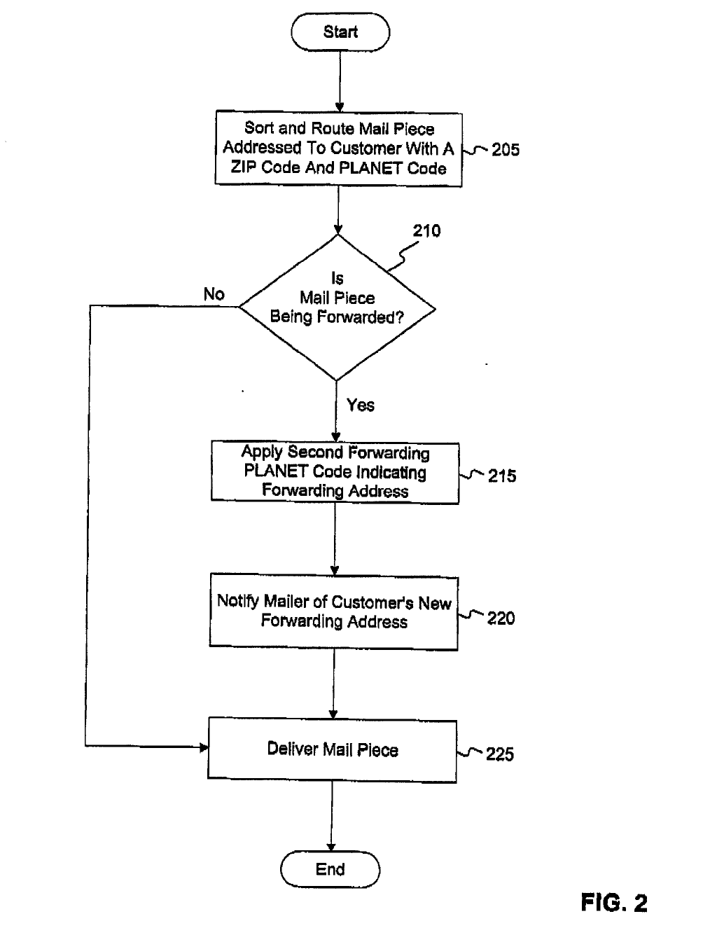

Referring now to FIG. 2 there is shown a flowchart of an exemplary process that is consistent with the principles of the present invention. In step 205, a mail piece 110 is processed according to its ZIP Code and PLANET code for sorting and routing to a customer. If the mail piece is not being forwarded to an address other than the address on the mail piece (step 210, No) then the mail piece is delivered as addressed (step 225), and the process ends.

If, on the other hand, the mail piece is being forwarded to an address other than the address on the mail piece (step 210, Yes) then a second forwarding PLANET code is applied (step 215), specifying the forwarding address.

In step 220, the mailer is notified of the customer's new forwarding address. In one embodiment, the mailer is notified by sending the mailer the original PLANET code, the forwarding PLANET code and the ZIP Code of the mail piece. In an alternative embodiment, the mailer uses the notification information to update its mailing list.

In step 225, the mail piece is delivered to the new forwarding address specified by the forwarding PLANET code, and the process ends.

In operation, the dynamic address change notification system works in the following manner. A mailer first applies labels on a mailpiece containing an address, a sender code and a destination code. The sender code may represent in bar code format the unique address of the mailer's customer. The destination code may represent in bar code format the mailer id, the mailpiece id, and the designated electronic route for the mailer to receive notifications.

Meanwhile, the mailer's customer has relocated. The delivery service receives advice of the new address and records this on a computerized system. When a letter carrier attempts delivery of the mailpiece he recognizes the addressee has relocated. He thereupon forwards the mailpiece to a forwarding unit. Within the forwarding unit, the mailpiece is sorted by a device appropriate for the coded system on the mailpiece. Where, for example, the sender code and destination code are in bar code format, the forwarding unit uses a bar code reader. In the process of reading the sender code and destination code, the delivery service converts this data into electronic form. Through computerized processing, the delivery service uses the sender code and destination code to further identify the forwarding address for the customer. The forwarding address has previously been entered into the computer system of the delivery service's forwarding unit. Once the forwarding unit has identified the forwarding address, through further computer processing the forwarding unit generates a forwarding sender code. The forwarding sender code is applied to the mail piece; this may be done in bar code format. The forwarding unit, upon creation of the forwarding sender code, sends an electronic notification to the mailer, through the route the mailer specified. The electronic notification comprises the sender code, the destination code, and the forwarding sender code. The delivery service completes the process be physically delivering the mail piece to the customer at his new address based on the forwarding sender code.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims which follow, the scope of which shall include all equivalents of the subject matter of the claims.

What is claimed is:

1. A method of automatically processing a mail item to be forwarded, comprising:
determining by a computer device and based on a mail item address that a mail item should be forwarded, wherein the mail item is to be sent by a mailer to a customer and includes a customer address and a destination code;
automatically generating a forwarding sender code by a computer for the mail item, the forwarding sender code having a forwarding address; and
generating a notification regarding delivery of the mail item to the forwarding address.

2. The method of claim 1, further comprising the step of identifying said forwarding sender code based on the destination code.

3. The method of claim 1, wherein the notification is sent to the mailer of the customer's forwarding address.

4. The method of claim 3, wherein the notification is directed to a mailer identification within a sender code also on the mail piece.

5. The method of claim 3, wherein the notification comprises:
the destination code; and
the forwarding sender code.

6. The method of claim 3 further comprising the step of updating a mailing list based upon the notification of the mailer.

7. A method of sending a mail piece with a customer's change of address comprising the steps of:
sending a first mail piece having a destination code to a customer;
receiving a notification of a forwarding sender code indicating a customer's change of address;
addressing a second mail piece to the customer using the customer's change of address received in the notification; and
sending the second mail piece to the customer.

8. The method of claim 7 further comprising the step of updating the customer's address on a mailing list with the forwarding address received in the notification.

9. The method of claim 7 further comprising the step of placing a sender code on the first mail piece wherein the sender code identifies the mailer sending the mail piece.
